(19) United States
(12) Patent Application Publication
(10) Pub. No.: US 2026/0204774 A1
(43) Pub. Date: Jul. 16, 2026

(54) Radome Enclosure

(71) Applicant: 4A Manufacturing GMBH, Traboch (AT)

(72) Inventors: Patrick Matthias HERGAN, Leoben (AT); Reinhard HAFELLNER, Speilberg (AT)

(21) Appl. No.: 19/130,941

(22) PCT Filed: Nov. 17, 2023
(86) PCT No.: PCT/EP2023/082198

§ 371 Date: May 16, 2025

(30) Foreign Application Priority Data
Nov. 18, 2022 (DE) 10 2022 130 630.5

(51) Int. Cl. H01Q 1/42

(52) U.S. Cl. CPC H01Q 1/422

(57) ABSTRACT

A radome-enclosure including at least one multilayer sheet stack having a plurality of sheets stacked above each other along a stacking direction, wherein at least one extending sheet of the multilayer sheet stack extends outside the multilayer sheet stack.

### CROSS REFERENCE TO RELATED APPLICATIONS

This application is a national stage application, filed under 35 U.S.C. § 371, of International Patent Application No. PCT/EP2023/082198, filed on Nov. 17, 2023, claiming priority of the filing date of the German Patent Application No. 10 2022 130 630.5, filed on Nov. 18, 2022, the disclosures of which are hereby incorporated by reference herein in their entirety.

### TECHNICAL FIELD

The present disclosure relates to a radome-enclosure for housing a radiation or receiving element of an antenna device and to a method of manufacturing the radome-enclosure.

### BACKGROUND

Radio frequency (RF) transmitters and/or receivers, in particular antenna devices, comprise respective radiation or receiving elements for radiating or receiving electromagnetic radiation. The radiation or receiving elements are housed and are protected by an enclosure, i.e. by a radome.

Radomes are useful to protect electronic systems from adverse weather conditions, such as rain, snow, fog, and the like. It may be preferable for a radome to be physically thin, as RF signal transparency and/or weight reduction is desired among other design requirements. A thin radome may, however, be susceptible to physical distortion, such as from gravity, wind loading or ice. This distortion, such as along a boresight of a protected antenna, may significantly change the RF transmission characteristics of the radome and, therefore, the antenna transmission/reception pattern, thus adversely affecting communication system performance.

Hence, there may be a need to provide a radome structure which does not adversely affect the transmitted antenna signals but on the other side provides a sufficient robustness.

### SUMMARY

This need may be met by a radome-enclosure for housing a radiation or receiving element of an antenna device, an antenna device and a method of manufacturing the radome-enclosure according to the subject matter of the independent claims.

According to first embodiment of the present disclosure, a radome-enclosure is presented. The radome-enclosure comprises at least one multilayer sheet stack having a plurality of sheets stacked above each other along a stacking direction, wherein at least one extending sheet of the multilayer sheet stack extends outside the multilayer sheet stack.

According to a further embodiment, an antenna device is presented. The antenna device comprises a supporting structure and a radiation or receiving element for radiating or receiving electromagnetic radiation. The antenna device further comprises an above-described radome-enclosure, wherein the radome-enclosure is mounted to the supporting structure for housing the radiation element.

According to a further embodiment, a method of manufacturing a radome-enclosure is presented. The method comprises the step of forming at least one multilayer sheet stack by stacking a plurality of sheets above each other along a stacking direction, wherein at least one extending sheet of the multilayer sheet stack extends outside the multilayer sheet stack.

### OVERVIEW OF EMBODIMENTS

The radome-enclosure and the multilayer sheet stack comprises of a plurality of sheets that are stacked layerwise above each other along the stacking direction. The sheets extend in a respective sheet plane which is spanned by lateral directions. The normal of a respective sheet plane is the stacking direction.

The sheets may be formed within respective straight planes. However, the sheets may be curved and may be formed within respective curved planes, respectively. Hence, the multilayer sheet stack may be formed in a desired three-dimensional shape in order to form a radome-enclosure in a desired shape. In an example embodiment, the radome-enclosure and the multiple sheet stack, respectively, forms a single curved stack (for forming e.g. a C-Shape) or multiple curved stack (e.g., a double curved stack for forming a dome, cupola shape). The dome shape of a double curved stack provides an enclosed inner volume for enclosing electrical components of an electronic (e.g. antenna) device. Sheets may further comprise different or the same material with respect to adjacent sheets. Furthermore, the thickness of the sheets of the stack may differ with respect to each other.

The radome-enclosure may form a housing for electrical components, such as transmitting or receiving elements, of an antenna device. Therefore, the radome-enclosure may be fixed to a supporting structure, on which the electrical components are mounted. The supporting structure may be a frame or a substrate. In an example embodiment, the supporting structure is an above-described radome-enclosure forming a housing half to which another housing half formed by another above-described radome-enclosure can be fixed.

According to the approach of the present disclosure, one of the sheets of the multilayer sheet stack forms an extending sheet extending along a lateral direction (perpendicular with respect to the attacking direction at edges of an adjacent sheet) and thereby forms sections that are noncovered by above or below arranged sheets. The noncovered section may be formed for providing different electromagnetic characteristics with respect to the other sheets of the stack. Furthermore, the noncovered section may be used to provide sufficient robustness for attaching the radome-enclosure to the supporting structure. By stacking all sheets including the extending sheet in one common stacking and lamination step, respectively, together, an efficient manufacturing of the radome-enclosure may be provided. Hence, by a radome-enclosure can be manufactured in one piece automatically and hence making an antenna assembly e.g. safe from weather.

According to a further example embodiment, at least one sheet of the multilayer sheet stack is a sheet having defined electromagnetic characteristics. Specifically, each sheet of the multilayer sheet stack is defined by a predefined electromagnetic characteristic for respective predefined wavelengths. Specifically, the radome enclosure according to the present disclosure is configured for providing proper electromagnetic characteristics for a frequency spectrum of more than 5 GHz and corresponding wavelength of the electromagnetic radiation. Hence, for an injection molded component, the electromagnetic characteristics become insufficient due to its absorbing properties for respective wavelengths in a frequency spectrum of 5 GHz or more. For wavelengths which correspond to frequencies higher than 5 GHz, the additional sheets of the multilayer sheet stack comprise a specific thickness and a specific material having defined electromagnetic characteristics so that a reflection of the electromagnetic radiation is minimized by e.g. defined reflections at the sheet interfaces and by the electromagnetic characteristics of the respective sheets. Hence, by the selection of the thickness and the dielectric constant of the sheets of the multilayer stack the electromagnetic damping characteristics of the radome enclosure can be minimized, specifically for wavelengths in the frequency spectrum of more than 5 GHz. The present radome enclosure may be designed also for a frequency spectrum of more than 100 GHz.

The relative permittivity, i.e. the dielectric constant, defines the permittivity of a material expressed as a ratio with the electric permittivity of a vacuum.

A dielectric is an insulating material, and the dielectric constant of an insulator measures the ability of the insulator to store electric energy in an electrical field. A loss factor is associated with dielectric power loss, wherein the loss factor is considered in the values for the relative permittivity as well. The dielectric constant of a respective sheet may be adapted to the field of application (i.e. the respective wavelengths of the electromagnetic radiation transmitted and received) of the radome-enclosure and the antenna device, respectively.

The radome-enclosure and in particular the multilayer sheet stack form in particular a so-called C-radome. In a C-radome, alternating layers of sheets are laminated to a stack in order to define a respective electromagnetic characteristics e.g. for broadband low loss performance and more complex bandpass tuning. As described below in more detail, a respective radome-enclosure may comprise the extending sheet, onto which for example an intermediate sheet is attached on a first surface of the extending sheet which is covered by a top sheet. A respective sheet stack comprising a further intermediate sheet and a top sheet may be attached on an opposing second surface of the extending sheet.

Alternatively, the radome-enclosure may form a radome-enclosure comprising one or more sheets of skin material, for structurally less demanding applications. A single layer wall which is constructed of a fiberglass or variant that may comprise a thickness lower than 1/10 and may be, depending on the chosen material, practically transparent to a respective impinging electromagnetic wave. In a further alternative embodiment of the radome-enclosure, the multilayer sheet stack forms a so-called A or B radome. For example, a lightweight core material may be provided to which sheets are laminated for added strength. Bandpass characteristics are tuned e.g. with inner core thickness of the core sheet(s), as outer face sheet thickness is set by structural properties. Preferably, the thickness of the sheet should be less than 1/10 of the wavelength of the radiation. Hence, by the stacked thin sheets in the multiple sheet stack forming a sandwich design according to the present disclosure, a bending stiffness and high strength can be achieved.

### EXAMPLE EMBODIMENTS

According to an example embodiment, the extending sheet comprises a greater dielectric constant with respect to the at least one adjacent sheets of the multilayer sheet stack. In particular, the extending sheet comprises a greater dielectric constant with respect to all other sheets of the multilayer sheet stack.

According to an example embodiment, the multilayer sheet stack comprises at least two sheets stacked above each other and fixed to the extending sheet, wherein the sheet closest to the extending sheet has a lower dielectric constant with respect to the extending sheet.

According to an example embodiment, the sheet closest to the extending sheet is arranged between a further (e.g. outer) sheet and the extending sheet, wherein the sheet as a lower dielectric constant than the further sheet.

According to an example embodiment, the further, e.g. outer, sheet has a lower dielectric constant than the extending sheet.

According to an example embodiment, the extending sheet comprises a thickness along the stacking direction of 0.001 mm to 10 mm, in particular 0.1 mm to 5 mm. For example, the thickness along the stacking direction may be less than 5 mm, less than 3 mm, less than 1 mm or less than 0.1 mm. Additionally or alternatively, the extending sheet comprises a dielectric constant (relative permittivity εr) between 2 and 100, in particular between 2.5 to 30 (for 21° C. and 35 GHz, measured e.g. according to Standard IPC-TM-650). For example, the dielectric constant (relative permittivity εr) may be less than 100, less than 30 or less than 3.

According to an example embodiment, a sheet (intermediate sheet, made for example of foam material) of the multilayer sheet stack adjacent to the extending sheet comprises a thickness along the stacking direction of 0.01 mm to 100 mm, in particular 0.1 mm to 50 mm, more in particular 0.5 mm to 20 mm. For example, the thickness along the stacking direction may more than 0.01 mm, more than 0.1 mm, more than 0.5 mm, more than 20 mm, more than 40 mm, more than 80 mm or more than 100 mm. Additionally or alternatively, the sheet of the multilayer sheet stack adjacent to the extending sheet comprises a dielectric constant (relative permittivity εr) between 1.001 to 2.5, in particular between 1.05 to 2.2 (for 21° C. and 35 GHz measured e.g. according to Standard IPC-TM-650). For example, the dielectric constant (relative permittivity εr) may be less than 2.5, less than 2.2 or less than 2.

The above-described sheet forms an intermediate sheet attached on the one side to the extending sheet and on the other side covered by a top sheet. Accordingly, also a plurality of intermediate sheets may be applied. Specifically, the intermediate sheet closest to the extending layer may be laminated directly to the extending sheet or may be fixed to the extending sheet by providing an adhesive layer between the intermediate sheet and the extending sheet.

According to an example embodiment, a sheet of the multilayer sheet stack being an outer sheet (top sheet) of the multilayer sheet stack comprises a thickness along the stacking direction of 0.001 mm to 5 mm, in particular 0.1 mm to 0.5 mm. For example, the thickness along the stacking direction may be less than 5 mm, less than 3 mm, less than 1 mm or less than 0.1 mm.

Additionally or alternatively, the outer sheet of the multilayer sheet stack comprises a dielectric constant (relative permittivity εr) between 2 to 10, in particular 2 to 8, more in particular between 2.5 to 6 (for 35 GHz measured e.g. according to Standard IPC-TM-650). For example, the dielectric constant (relative permittivity εr) may be less than 10, less than 8 or less than 2.7. Specifically, the outer sheet may be additionally covered by a protective layer, i.e. a protective coating. The outer sheet may be attached to the intermediate sheet or directly to the extending sheet. The outer sheet may be laminated directly to the extending sheet or intermediate sheet or may be fixed to the extending sheet or intermediate sheet by providing an adhesive layer between the respective adjacent sheets.

According to a further example embodiment, the radome-enclosure further comprises a protective layer attached to a surface of the multilayer sheet stack. The protective layer is configured for forming in particular a watertight surface or UV protective surface. The protective layer may function as a sealing layer and may fully cover the top layer of the multilayer sheet stack. Additionally, the protective layer may partially or fully cover the extending layer in order to provide a respective protection against mechanical impacts, such as stones or hailstones, or humidity/water. The protective layer may be attached to the multilayer sheet stack in a subsequent manufacturing step after manufacturing the complete multilayer sheet stack including the manufacturing of the extending sheet.

According to a further example embodiment, the protective layer and/or the outer sheet is made of a thermoplastic material or a thermosetting material, in particular glass fiber reinforced material (e.g. FR4). By using a robust FR4 material, protection against e.g. humidity and sufficient strength against mechanical impacts can be provided.

According to a further example embodiment, the protective layer is a coated layer. Hence, by coating the protective layer, a complex shaped radome-enclosure may be covered at all areas with the protective layer.

According to a further example embodiment, the extending sheet comprises at least one covered section being covered by at least one other sheet of the multilayer sheet stack and at least one extending section being noncovered by sheets of the multilayer sheet stack. The covered section defines a section of the extending sheet that is covered at least on one side with further sheets of the multilayer sheet stack. The extending section forms a section of the extending sheet that is noncovered by any sheet of the multilayer sheet stack on both sides. Specifically, the extending section surrounds a covered section of the extending sheet. In other words, along lateral edges of the covered section, the extending section is formed.

However, in an alternative embodiment, the extending section is only formed at specific lateral edges of the covered section, such that some edges of the covered section and hence a lateral edge of the multilayer sheet stack does not comprise an extending section of the extending sheet. In other words, in an alternative embodiment, the extending section does not fully surround the covered section of the extending sheet.

According to a further example embodiment, the thickness of the covered section of the extending sheet has a different thickness in stacking direction with respect to the extending section of the extending sheet. Hence, due to stability reasons or due to a desired electromagnetic characteristic for predefined wavelengths, thickness of the extending sheet may vary.

According to a further example embodiment, the thickness of the extending section of the extending sheet is greater than the thickness of the covered section of the extending sheet. Hence, in the extending section of the extending sheet, higher strength and robustness of the extending sheet may be provided. Additionally, a respective, for example lower, electromagnetic transparency, and a higher electromagnetic shielding characteristic for a specific wavelength may be provided in the extending section with respect to the thinner cover section. Hence, the thicker extending section may function for example as a shielding section with respect to the cover section, such that the electromagnetic radiation or the receiving of electromagnetic waves of an antenna device may be controlled and directed, respectively.

Specifically, the thinner covered section may form a recess and a cavity, respectively, in which the further sheets of the multilayer stack may be attached and stacked along the stacking direction. The deepness of the recess may be designed in such a manner, that the top sheet of the multilayer sheet stack flushes with a surface of the extending sheet at the extending section, such that a homogeneous surface of the radome-enclosure can be formed. Above the surface of the extending sheet and the surface of the top sheet width in the recess, the protective layer may be applied.

According to a further example embodiment, the extending section of the extending sheet comprises an attachment for being fixed to a supporting structure supporting the radome-enclosure. The attachment comprises a screw connection means, in particular a screw element or a threaded hole, a clicking detent, in particular a snap-in hole or snap-in pin, and/or an adhesive section for receiving adhesive for providing a glued joint. As described above, the supporting structure may be a frame or a substrate. In an example embodiment, the supporting structure is an above-described radome-enclosure forming a housing half to which another housing half formed by another above-described radome-enclosure can be fixed.

The extending sheet may comprise for example a threaded through hole, in which a respective screw element may be fixed. Furthermore, the extending sheet may comprise for example a plane gluing surface at which a respective adhesive may be applied for providing sufficient strong adhesive forces.

According to a further example embodiment, the extending section of the extending sheet comprises a higher dielectric constant than the covered section. Hence, the extending section may function as a shielding section with respect to the enclosed covered section. In order to achieve the higher dielectric constant of the extending section, the extending section may be coated by a coating having for example a dielectric constant εr of more than 30, 50, 100, 200 or 1000.

According to a further example embodiment, an extending section and the covered section comprise a common base material, such as injection molding material (e.g. Polycarbonate), wherein the extending section comprises additives configured for increasing the dielectric constant. The additives may be particles comprising a greater dielectric constant comparison to the base material of the covered section. For example, the additive material together with the additive concentration may provide a dielectric constant of more than 100, in particular more than 1000.

According to further example embodiment, the extending section and the covered section are made of different materials having different dielectric constants. For example, a respective extending sheet may be formed in a multi-material injection molding (MMM), wherein two or more different materials into one plastic part can be formed in one mold. Hence, an integral and monolithic extending sheet can be formed having sections with materials forming different dielectric constants. The sections may provide an adhesive bond between its mold materials.

According to a further example embodiment, the extending sheet comprises a plurality of spaced covered sections. Accordingly, a radome-enclosure according to the present disclosure may comprise an extending sheet having only one covered section surrounded by a respective extending section but, as described above, also an extending sheet having a plurality of covered sections being surrounded by the respective extending section. To all covered sections of the extending sheet, respective further sheets of the multilayer sheet stack may be arranged and laminated for forming the multilayer sheet stack. For example, the buildup stacks in each covered section may have symmetrical sheet stack-ups. In an alternative embodiment, the sheet stack-ups in the covered sections may differ with respect to each other, so that for example the electromagnetic characteristic may be adjusted and may differ between the covered sections. Hence, a radome-enclosure being fitted to a specific field of application and fitted to a specific antenna device is provided. For example, below a first cover section of the radome-enclosure, an electromagnetic radiation element may be arranged and below a second cover section, an electromagnetic receiving element may be arranged, wherein the first cover section and the second cover section may be adjusted to the respective wavelength spectrum by the respective stack build-ups in the respective cover sections.

According to a further example embodiment, the sheets of the multilayer sheet stack are fixed together by providing an adhesive between adjacent sheets and/or by directly bonding adjacent sheets together by heat pressing or cold curing without providing an adhesive layer between the two adjacent sheets. For example, the sheets may be made e.g. of a thermoplastic material that becomes pliable or moldable at a certain elevated temperature and solidifies upon cooling. Hence, in a lamination process, the sheets may be heated and pressed together, wherein upon cooling the stack of sheets, respective binding forces and adhesive forces between adjacent sheets are generated. A sheet of the multilayer sheet stack may also be for example an uncured prepreg material (i.e. thermoset material), that can be cured after applying heat and pressure.

According to a further example embodiment the multilayer sheet stack comprises an even or odd number of sheets. In an example embodiment, above and below a central extending sheet, two further sheets may be added, such that the multilayer sheet stack comprises in sum five sheets. However, in alternative embodiments, to the extending sheet 1, 3 or 5 or more sheets may be fixed together in a stacking direction, such that in sum the multilayer sheet stack comprises 2, 4 or 6 or more sheets. Furthermore, to each opposing side of the extending sheet different numbers of sheets or the same number of sheets may be applied.

According to a further example embodiment, the extending sheet comprises a first surface being partially covered with sheets of the multilayer sheet stack and a second surface opposite to the first surface being noncovered by the sheets of the multilayer sheet stack. By the described example embodiment, the extending sheet forms a top or a bottom sheet, respectively. If the extending sheet forms the top sheet, the extending sheet faces the environment of the radome-enclosure. However, in this example embodiment, a further protective layer may be fixed as well, wherein the further protective layer does not form part of the multilayer sheet stack. If the extending sheet forms a bottom sheet, the extending sheet faces an internal volume of the antenna device, such that the extending sheet faces for example internal devices, such as a transmitting or receiving element of the antenna device, and such that the outer layer of the multilayer sheet stack opposed to the extending sheet faces the environment of the radome-enclosure.

According to a further example embodiment, the extending sheet comprises a first surface and an opposing second surface being partially covered with sheets of the multilayer sheet stack. According to the present example embodiment, the extending sheet forms a central sheet within the multilayer sheet stack.

According to a further example embodiment, the number of sheets covering the first surface of the extending sheet is equal to the number of sheets covering the second surface of the extending sheet. Hence, a symmetrical build up on both sides of the extending sheet is provided.

According to a further example embodiment, the radome-enclosure further comprises a sealing element, in particular a sealing lip and/or a sealing ring, being attached to the extending sheet for sealing the radome-enclosure with respect to a supporting structure supporting the radome-enclosure. Hence, an antenna device may be provided that is e.g. watertight and the risk that dust particles enter the inner volume of the antenna device is reduced.

According to a further example embodiment, wherein the extending sheet is an injection molded sheet (e.g. a sheet that is formed by injection molding, specifically by a multi-material injection molding (MMM)), a printed sheet (e.g. a sheet that is formed by additive manufacturing), a deep drawn sheet (e.g. formed by thermoforming on a basis of an extruded film or foil, a pressed prepreg, respectively) and/or a machined sheet (e.g. a sheet that is formed by cutting or milling processes by milling material).

According to a further example embodiment, the extending sheet is made from polymer material, in particular being free of reinforcing fibers, in particular glass fibers, or comprising reinforcing fibers, in particular glass fibers or polymer fibers, such as PE fibers, PET fibers or Aramid fibers. As described above, the extending sheet may be initially used as a prepreg sheet or as an organosheet which is later on cured under pressure and heat in order to form a robust and rigid extending sheet.

The above-described polymer material comprises for example at least one of the following materials: polyethylene terephthalate (PET), Polyamide (PA), Polycarbonate (PC), Polyethylene (PE), Polybutylene (PB), Terephthalate (PET), Polypropylene (PP), Acrylonitrile styrene acrylate (ASA), poly(p-phenylene ether) (PPE), Acrylnitril-Butadien-Styrol (ABS), Epoxy and Liquid-crystal polymer (LCP).

According to a further example embodiment, at least one sheet of the multilayer sheet stack is a foam sheet, in particular a syntactic foam, or a porous ceramic sheet. The foam material may comprise cells, being open cells or closed cells. The foam sheet comprises in particular at least one of the following materials: Polymethacrylimide (PMI), Polyethylene terephthalate (PET), Polyvinyl chloride (PVC), Polystyrene (PS), Polyurethane (PUR), Polyphenylsulfone (PPSU), Polyethersulfone (PESU), Epoxy foam, Styrene-acrylonitrile (SAN) and Polyphenyl ether (PPE). For example, syntactic foams are composite materials synthesized by filling a polymer, or a ceramic matrix with hollow spheres called microballoons or cenospheres or non-hollow spheres (e.g. perlite). The presence of hollow particles results in lower density, higher specific strength (strength divided by density), lower coefficient of thermal expansion, and may provide low relative permittivity.

According to an example embodiment of the method, the extending sheet is formed by injection molding. Specifically, the injection molding comprises a multi-material injection molding (MMM) such that an extending sheet made of two or more different materials can be molded. Additionally, a foil back molding may be applied. Therefore, according to an example embodiment of the present disclosure, a foil element is arranged in a mold. A mold material is injected in the mold for forming an extending section of the extending sheet and an opening in the extending sheet being covered by the foil element. For example, sheets of the multilayer sheet stack can be attached in the opening to the foil element.

Furthermore, by applying the multi-material injection molding (MMM) method, in the opening, a further injection mold material can be injected before attaching the further sheet of the multilayer sheet stack to the extending section.

It has to be noted that embodiments of the disclosure have been described with reference to different subject matters. In particular, some embodiments have been described with reference to apparatus type claims whereas other embodiments have been described with reference to method type claims. However, a person skilled in the art will gather from the above and the following description that, unless otherwise notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present disclosure are apparent from the examples of embodiment to be described hereinafter and are explained with reference to the examples of embodiment. The disclosure will be described in more detail hereinafter with reference to examples of embodiment but to which the disclosure is not limited.

FIG. 1 illustrates a schematic view of a radome-enclosure according to an example embodiment of the present disclosure.

FIG. 2 illustrates a schematic view of a C-radome of a radome-enclosure according to an example embodiment of the present disclosure.

FIG. 3 illustrates a schematic view of a radome-enclosure having an extending sheet with a different thickness according to an example embodiment of the present disclosure.

FIG. 4 illustrates a schematic view of a radome-enclosure having an extending sheet with a different thickness, wherein an outer sheet is flush with a top surface of an extending section of the extending sheet according to an example embodiment of the present disclosure.

FIG. 5 illustrates a schematic view of a radome-enclosure having an extending sheet having different base materials according to an example embodiment of the present disclosure.

FIG. 6 illustrates a schematic view of a radome-enclosure having an extending sheet with attachment means according to an example embodiment of the present disclosure.

FIG. 7 illustrates a schematic view of a radome-enclosure having a protective coating according to an example embodiment of the present disclosure.

FIG. 8 illustrates a schematic view of a radome-enclosure in a C-radome buildup having a protective coating according to an example embodiment of the present disclosure.

FIG. 9 illustrates a schematic view of a radome-enclosure having an opening covered by a foil according to an example embodiment of the present disclosure.

FIG. 10 illustrates a schematic view of a radome-enclosures forming housing halves according to an example embodiment of the present disclosure.

FIG. 11 illustrates a schematic view of an antenna device comprising a radome-enclosure mounted to a supporting structure according to an example embodiment of the present disclosure.

### DETAILED DESCRIPTION OF THE ILLUSTRATED EMBODIMENTS

The illustrations in the drawings are schematically presented. It is noted that in different figures similar or identical elements are provided with the same reference signs.

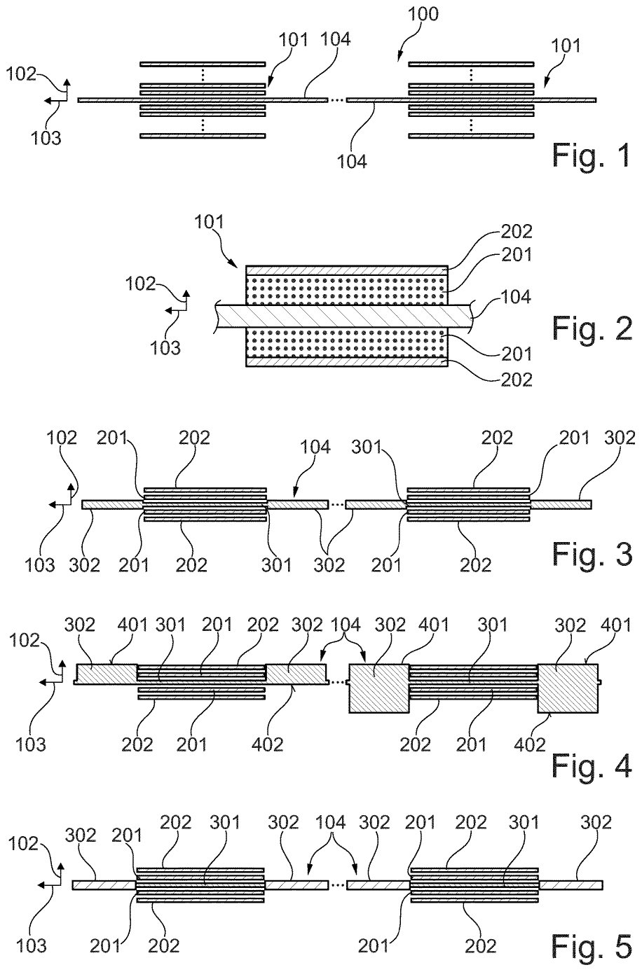

FIG. 1 shows a radome-enclosure 100 according to an example embodiment of the present disclosure. The radome-enclosure 100 comprises at least one multilayer sheet stack 101 having a plurality of sheets stacked above each other along a stacking direction 102, wherein at least one extending sheet 104 of the multilayer sheet stack 101 extends outside the multilayer sheet stack 101. The radome-enclosure 100 and the multilayer sheet stack 101, respectively comprise of a plurality of sheets that are stacked layerwise above each other along the stacking direction 101. The sheets extend in a respective sheet plane which is spanned by lateral directions 103.

The sheets may be formed within respective straight planes. However, the sheets may be curved and may be formed within respective curved planes, respectively. Hence, the multilayer sheet stack 101 may be formed in a desired three-dimensional shape in order to form a radome-enclosure 100 in a desired shape (see e.g. FIG. 11).

One of the sheets of the multilayer sheet stack 101 forms the extending sheet 104 extending along the lateral direction 103 (i.e. perpendicular with respect to the attacking direction at edges of an adjacent sheet) and thereby forms sections that are noncovered by above or below arranged sheets. The noncovered section may be formed for providing different electromagnetic characteristics with respect to the other sheets of the stack 101. Furthermore, the noncovered section may be used to provide sufficient robustness for attaching the radome-enclosure 100 to the supporting structure 1102.

The sheets of the multilayer sheet stack 101 comprise a defined electromagnetically characteristic for respective wavelengths. The relative permittivity, i.e. the dielectric constant, defines the permittivity of a material expressed as a ratio with the electric permittivity of a vacuum. The sheets of the multilayer sheet stack 101 are fixed together by providing an adhesive between adjacent sheets and/or by directly bonding adjacent sheets together by heat pressing or cold curing without providing an adhesive layer between the two adjacent sheets.

As indicated in FIG. 1, the multilayer sheet stack 101 comprises an even or odd number of sheets. Above and below the extending sheet 104, two or more further sheets may be added, such that the multilayer sheet stack 101 comprises in some five sheets. However, in alternative embodiments, to the extending sheet 104 1, 3, 5 or more sheets may be attached in stacking direction 102.

In the example embodiment shown in FIG. 1, the extending sheet 104 comprises a first surface and an opposing second surface being partially covered with sheets of the multilayer sheet stack 101. According to the present example embodiment, the extending sheet 104 forms a central sheet within the multilayer sheet stack 101. For example, the number of sheets covering the first surface of the extending sheet 104 is equal to the number of sheets covering the opposing second surface of the extending sheet 104. Hence, a symmetrical build up on both sides of the extending sheet 104 is provided. In an alternative embodiment, the extending sheet 104 must not be a central sheet, so that the number of sheets covering the first surface of the extending sheet 104 may differ to the number of sheets covering the opposing second surface of the extending sheet 104. Furthermore, also more than one extending sheet 104 may be applied in the multiple sheet stack 101.

FIG. 2 illustrates a schematic view of a C-radome of a radome-enclosure 100 according to an example embodiment of the present disclosure. Hence, alternating layers of sheets are laminated to a stack 101 in order to define a respective electromagnetic characteristic e.g. for broadband low loss performance and more complex bandpass tuning. Onto the extending sheet 104 an intermediate sheet 201 is attached on a first surface of the extending sheet 104 which is covered by a top outer sheet 202. A further intermediate sheet 201 and a further top sheet 202 may be attached on an opposing second surface of the extending sheet 104.

The extending sheet 104 comprises a thickness along the stacking direction 102 of 0.1 mm to 5 mm. The extending sheet 104 comprises a dielectric constant (relative permittivity εr) in particular between 2.5 to 30 (for 21° C. and e.g. 35 GHz).

The intermediate sheet 201 is made for example of foam material and formed adjacent to the extending sheet 104. The intermediate sheet 201 comprises a thickness along the stacking direction 102 of 1 mm to 20 mm and is in particular thicker than the extending sheet 104. The intermediate sheet 201 adjacent to the extending sheet 104 comprises a dielectric constant (relative permittivity εr) between 1.05 to 2.2 (for 21° C. and 35 GHz). The intermediate sheet 201 is attached on the one side to the extending sheet 104 and on the other side covered by the top sheet 202. Accordingly, a plurality of intermediate sheets 201 may be applied.

The outer sheet (top sheet) 202 comprises a thickness along the stacking direction 102 0.1 mm to 0.5 mm. The outer sheet 202 of the multilayer sheet stack 101 comprises a dielectric constant (relative permittivity εr) between 2.5 to 6. Specifically, the outer sheet 202 may be additionally covered by a protective layer 701, i.e. a protective coating (see FIG. 7).

The extending sheet 104 may comprise a greater dielectric constant with respect to the intermediate sheets 201 of the multilayer sheet stack 101. In an exemplary embodiment. The extending sheet 104 may comprise a greater dielectric constant with respect to all other intermediate sheets 201 and e.g. the outer sheets 202.

In the shown embodiment, the multilayer sheet stack 101 comprises an intermediate sheet 201 and an outer sheet 202 stacked above each other and fixed to the extending sheet 104. The intermediate sheet 201 closest to the extending sheet 104 has a lower dielectric constant with respect to the extending sheet 104.

The intermediate sheet(s) 201 closest to the extending sheet 104 is arranged between a further, e.g. outer, sheet 202 and the extending sheet 104, wherein the intermediate sheet(s) 201 has a lower dielectric constant than the outer sheet 202.

In an example embodiment, a plurality of intermediate sheets 201 may be stacked above each other and arranged between the outer sheet 202 and the extending sheet 104. In a direction from the outer sheet 202 to the extending sheet 104, the next inner intermediate sheet 201 has a lower dielectric constant than the adjacent outer intermediate sheet 201. In other words, the closer the intermediate sheet 201 to the extending sheet 104 the lower the dielectric constant.

FIG. 3 illustrates a schematic view of a radome-enclosure 100 having an extending sheet 104 with a different thickness according to an example embodiment of the present disclosure.

The extending sheet 104 comprises at least one covered section 301 being covered by at least one other sheet of the multilayer sheet stack 101 and at least one extending section 302 being noncovered by sheets of the multilayer sheet stack 101. The covered section 301 defines a section of the extending sheet 104 that is covered at least on one surface with further sheets of the multilayer sheet stack 101. The extending section 302 forms a section of the extending sheet 104 that is noncovered by any sheet of the multilayer sheet stack 101 on both sides.

The extending sheet 104 comprises in the illustrated example embodiment a plurality of spaced covered sections 301 (see FIG. 3). Accordingly, a radome-enclosure 100 may comprise an extending sheet 104 having only one covered section surrounded by a respective extending section 302 but as shown in FIG. 3, also an extending sheet 104 having a plurality of covered sections 301 being surrounded by the respective extending section 302. To all covered sections 301 of the extending sheet 104, the respective further sheets of the multilayer sheet stack 101 are laminated for forming the multilayer sheet stack 101. The buildup stacks in each covered section 301 may have symmetrical sheet stack-ups. In an alternative embodiment, the sheet stack-ups in the covered sections 301 may differ with respect to each other, so that for example the electromagnetic characteristic may be adjusted and may differ between the covered sections 301.

The thickness of the covered section 301 of the extending sheet 104 has a different thickness in stacking direction 102 with respect to the extending section 302 of the extending sheet 104. Hence, due to stability reasons or due to a desired electromagnetic characteristic, thickness of the extending sheet 104 may vary. In the shown example, the thickness of the extending section 302 of the extending sheet 104 is greater than the thickness of the covered section 301 of the extending sheet 104. Hence, in the extending section 301 of the extending sheet 104, higher strength and robustness of the extending sheet 104 may be provided. Additionally, a respective, for example lower, electromagnetic characteristic may be provided in the extending section 302 with respect to the thinner cover section 301.

The extending section 302 of the extending sheet 301 may comprise a higher dielectric constant than the covered section 301. Hence, the extending section 302 may function as a shielding section with respect to the enclosed covered section 301.

FIG. 4 illustrates a schematic view of a radome-enclosure 100 having an extending sheet 104 with a different thickness, wherein an outer sheet 202 is flush with a top surface 401 of an extending section 302 of the extending sheet 104 according to an example embodiment of the present disclosure. The thinner covered section 301 may form a cavity at the top surface 401 for accommodating further sheets of the multilayer stack 101 which are stacked along the stacking direction 102. The deepness of the cavity is designed in such a manner that the top sheet 202 of the multilayer sheet stack 101 is flush with the outer top surface 401 of the extending sheet 104 at the extending section 302, such that a homogeneous surface of the radome-enclosure 100 can be formed. In a further example embodiment, the deepness of the cavity in the bottom surface 402 may also be designed in such a manner that the top sheet 202 adjacent to the bottom surface 402 is flush as well with the bottom surface 402 of the extending sheet 104 at the extending section 302. Above the surface of the extending sheet 104 and the surface of the top sheet 202 inside the recess, a protective layer 701 (see FIG. 7) may be applied.

The bottom surface 402 of the extending sheet 104 opposite to the top surface 401 may be free of a cavity and may have a uniform homogeneous extension. The sheets 201, 202 fixed to the bottom surface 402 of the extending sheet 104 may protrude in stacking direction from the bottom surface 402 and protrudes therefore also from the bottom surface 402 of the extending layer 104 (see left side of FIG. 4).

However, the bottom surface 402 of the extending sheet 104 opposite to the top surface 401 have a deep cavity enclosing all sheets 201, 202 of the multiple sheet stack 101. The sheets 201, 202 fixed to the bottom surface 402 of the extending sheet 104 not protrude in stacking direction from the bottom surface 402 and therefore still a step between the bottom surface 104 in the extending section 302 and the adjacent top sheet 202 exist (see right side of FIG. 4).

The top surface 401 of the extending sheet 104 and the flush adjacent top sheet 202 may form an outer side of the radome enclosure 100. The bottom surface 402 of the extending sheet 104 and the respective adjacent top sheet 202 may form an inner side of the radome enclosure 100 facing the interior of an electronic device, i.e. an antenna device. However, in further example embodiments, the bottom surface 302 may be the surface forming an outer side of the radome enclosure 100. In addition, the inner or outer surface 401, 402 may be enclosed by a protective layer 701 (see FIG. 7).

FIG. 5 illustrates a schematic view of a radome-enclosure 100 having an extending sheet 104 having different base materials according to an example embodiment of the present disclosure. The extending section 302 and the covered section 302 are made of different materials having different dielectric constants. For example, a respective extending sheet 104 may be formed in a multi-material injection molding (MMM), wherein two or more different materials into one plastic part can be formed in one molding step.

Alternatively, the extending section 302 and the covered section 301 may comprise a common base material, wherein the extending section 302 comprises additives configured for increasing the dielectric constant. The additives may be particles comprising a greater dielectric constant comparison to the base material of the covered section 301.

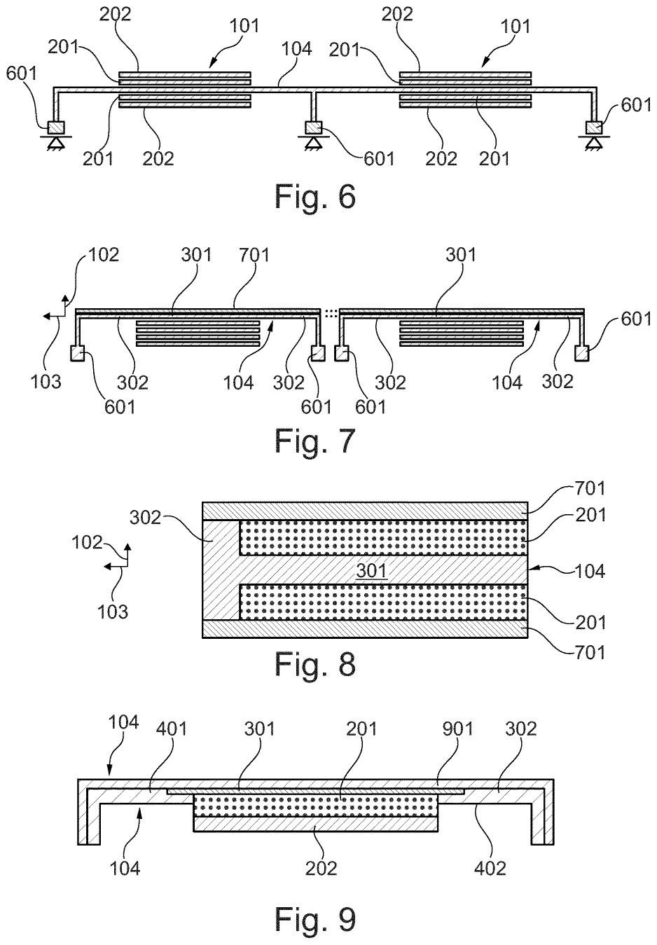

FIG. 6 illustrates a schematic view of a radome-enclosure 100 having an extending sheet 104 with attachment 601 according to an example embodiment of the present disclosure. The attachment 601 is configured for being fixed to a supporting structure 1102 (see FIG. 11) supporting the radome-enclosure 100. The attachment 601 comprises e.g. a screw connection, in particular a screw element or a threaded hole, a clicking detent, in particular a snap-in hole or snap-in pin, and/or an adhesive section for receiving adhesive for providing a glued joint.

FIG. 7 illustrates a schematic view of a radome-enclosure 100 having a protective coating 701.

The extending sheet 104 comprises a first surface being partially covered with sheets of the multilayer sheet stack 101 and a second surface opposite to the first surface being noncovered by the sheets of the multilayer sheet stack. Hence, the extending sheet 104 forms a top or a bottom sheet, respectively. If the extending sheet 104 forms the top sheet, the extending sheet faces the environment of the radome-enclosure 100. The protective layer 701 is attached to the outer surface of the extending sheet 104.

FIG. 8 illustrates a schematic view of a radome-enclosure 100 in a C-radome buildup having a protective layer 701. The protective layer 701 is attached on a surface of the multilayer sheet stack 101. The protective layer 701 is configured for forming in particular a watertight surface. The protective layer 701 may function as a sealing layer and may fully cover the top layer of the multilayer sheet stack 101. The protective layer 701 is attached to the multilayer sheet stack 101 in the same or in a subsequent manufacturing step after manufacturing the complete multilayer sheet stack 101 including the manufacturing of the extending sheet 104. The protective layer 701 is made of a thermoplastic material or a thermosetting material, in particular FR4.

FIG. 9 illustrates a schematic view of a radome-enclosure 100 having an opening covered by a foil element 901 according to an example embodiment of the present disclosure. The extending sheet 104 is formed by injection molding. For example, a foil back molding is applied. Therefore, the foil element 901 is arranged in a mold. A mold material is injected in the mold for forming the extending section 302 of the extending sheet 104 and an opening in the extending sheet 104 being covered by the foil element 901. For example, sheets 201, 202 of the multilayer sheet stack are attached in the opening to the foil element 901. The foil element 901 may only be applied in the region of the covered section 301 of the extending sheet 104 or may fully cover the top surface 401 of the extending sheet 104 in the covered section 301 and extending section 302. In the foil back molding step, injection molding material for the covered section 301 of the extending sheet 104 may be applied which is the same base material or a different base material with respect to the extending section 302 of the extending sheet 104.

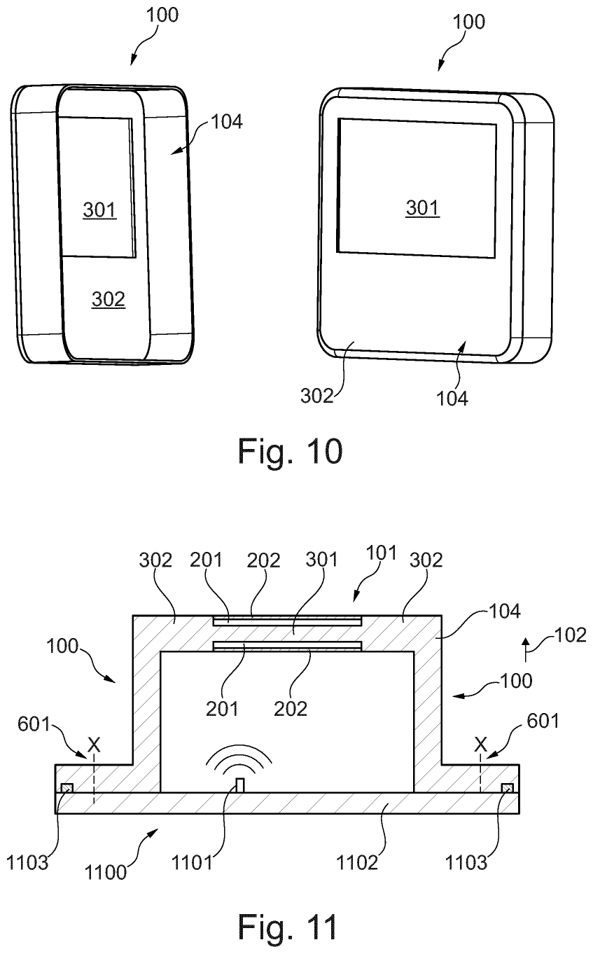

FIG. 10 illustrates a schematic view of a radome-enclosures 100 forming housing halves according to an example embodiment of the present disclosure. Both housing halves can be fixed together. One housing half may, for example, carry the electronic components of an electronic device. The extending section 302 of the extending sheet 104 surrounds a covered section 301 of the extending sheet 104. Along lateral edges of the covered section 301, the extending section 302 is formed. The covered section 302 of the extending sheet 104 is formed by a cavity. In the cavity, further sheets of the multilayer sheet stack 101 may be laminated. As can be seen in FIG. 10, the edges of the extending section 302 are bent so that the radome-enclosures 100 form a 3-dimensional shape. At the extending sections 302 respective attachment means 601 in form of a clicking/snapping means can be provided. For example, one housing half may comprise a snap-in hole and the other housing half may comprise a respective snap-in pin.

FIG. 11 illustrates a schematic view of an antenna device 1100 comprising a radome-enclosure 100 mounted to a supporting structure 1102 according to an example embodiment of the present disclosure.

The radome-enclosure 100 forms a housing for electrical components, such as transmitting or receiving elements 1101, of an antenna device 1100. The electrical components are mounted to the supporting structure 1102. The extending sheet 104 may comprise for example a threaded through hole as attachment means 601, in which a respective screw element may be fixed. Furthermore, the extending sheet 104 may comprise for example a plane gluing surface at which a respective adhesive may be applied for providing sufficient strong adhesive forces.

The radome-enclosure 100 further comprises a sealing element 1103, in particular a sealing lip and/or a sealing ring, being attached to the extending sheet 104 for sealing the radome-enclosure 101 with respect to the supporting structure 1102 supporting the radome-enclosure 100.

It should be noted that the term “comprising” does not exclude other elements or steps and the article “a” or “an” does not exclude a plurality. Also, elements described in association with different embodiments may be combined.

### LIST OF REFERENCE SIGNS

100 radome-enclosure
101 multilayer sheet stack
102 stacking direction
103 lateral direction
104 extending sheet
201 intermediate sheet
202 outer/further sheet
301 covered section
302 extending section
401 top surface
402 bottom surface
601 attachment means
701 protective layer
901 foil
1100 antenna device
1101 radiation or receiving element
1102 supporting structure
1103 sealing element

1. A radome-enclosure, comprising:
at least one multilayer sheet stack having a plurality of sheets stacked above each other along a stacking direction,
wherein at least one extending sheet of the multilayer sheet stack extends outside the multilayer sheet stack.

2. The radome-enclosure according to claim 1,
wherein the multilayer sheet stack forms a single or double curved stack.

3. The radome-enclosure according to claim 1, comprising at least one of the following features
wherein the extending sheet comprises a greater dielectric constant with respect to the at least one adjacent sheets of the multilayer sheet stack,
wherein the multilayer sheet stack comprises at least two sheets stacked above each other and fixed to the extending sheet, wherein the sheet closest to the extending sheet has a lower dielectric constant with respect to the extending sheet;
wherein the sheet closest to the extending sheet is arranged between a further sheet and the extending sheet,
wherein the sheet has a lower dielectric constant than the further sheet, and
wherein the further sheet has a lower dielectric constant than the extending sheet.

4.-6. (canceled)

7. The radome-enclosure according to claim 1, comprising at least one of the following features
wherein the extending sheet comprises a thickness along the stacking direction of 0.001 mm to 10 mm and/or,
wherein the extending sheet comprises a dielectric constant between 2 and 100,
wherein a sheet of the multilayer sheet stack adjacent to the extending sheet comprises a thickness along the stacking direction of 0.01 mm to 100 mm and/or,
wherein the sheet of the multilayer sheet stack adjacent to the extending sheet comprises a dielectric constant between 1.001 to 2.5,
wherein a sheet of the multilayer sheet stack being an outer sheet of the multilayer sheet stack comprises a thickness along the stacking direction of 0.001 mm to 5 mm, and/or
wherein the outer sheet of the multilayer sheet stack comprises a dielectric constant between 2 to 10.

8.-9. (canceled)

10. The radome-enclosure according to claim 1, further comprising:
a protective layer attached on a surface of the multilayer sheet stack,
wherein the protective layer is configured for forming a watertight surface or UV protective surface,
wherein the protective layer and/or the outer sheet is made of a thermoplastic material or a thermosetting material.

11. (canceled)

12. The radome-enclosure according to claim 10,
wherein the protective layer is a coated layer.

13. The radome-enclosure according to claim 1,
wherein the extending sheet comprises at least one covered section being covered by at least one other sheet of the multilayer sheet stack and at least one extending section being noncovered by sheets of the multilayer sheet stack.

14. The radome-enclosure of claim 13, comprising at least one of the following features
wherein the thickness of the covered section of the extending sheet has a different thickness in stacking direction with respect to the extending section of the extending sheet,
wherein the thickness of the extending section of the extending sheet is greater than the thickness of the covered section of the extending section of the extending sheet,
wherein the extending section of the extending sheet comprises an attachment for being fixed to a supporting structure supporting the radome-enclosure,
wherein the attachment comprises a screw connection, a detent, and/or an adhesive section for receiving adhesive for providing a glued joint.

15.-16. (canceled)

17. The radome-enclosure according to claim 13,
wherein the extending section of the extending sheet comprises a higher dielectric constant than the covered section.

18. The radome-enclosure of claim 17,
wherein extending section and the covered section comprise a common base material,
wherein the extending section comprises additives configured for increasing the dielectric constant.

19. The radome-enclosure of claim 17,
wherein the extending section and the covered section are made of different materials having different dielectric constants.

20. The radome-enclosure according to claim 13,
wherein the extending sheet comprises a plurality of spaced covered sections.

21. The radome-enclosure according to claim 1,
wherein the sheets of the multilayer sheet stack are fixed together by providing an adhesive between adjacent sheets and/or by directly bonding adjacent sheets together by heat pressing or cold curing without providing an adhesive layer between the two adjacent sheets.

22. The radome-enclosure according to claim 1,
wherein the multilayer sheet stack comprises an even or odd number of sheets.

23. The radome-enclosure (100) according to claim 1, comprising at least one of the following features
wherein the extending sheet (104) comprises a first surface being partially covered with sheets of the multilayer sheet stack and a second surface opposite to the first surface being noncovered by the sheets of the multilayer sheet stack,
wherein the extending sheet comprises a first surface and an opposing second surface being partially covered with sheets of the multilayer sheet stack,
wherein the number of sheets covering the first surface of the extending sheet is equal to the number of sheets covering the second surface of the extending sheet.

24.-25. (canceled)

26. The radome-enclosure according to claim 1, further comprising:
a sealing element attached to the extending sheet for sealing the radome-enclosure with respect to a supporting structure supporting the radome-enclosure.

27. The radome-enclosure according to claim 1, comprising at least one of the following features:
wherein the extending sheet is an injection molded sheet, a printed sheet, a deep drawn sheet, a thermoformed sheet, and/or a machined sheet,
wherein the extending sheet is made from polymer material,
wherein the polymer material comprises at least one of the following materials:
polyethylene terephthalate,
Polyamide,
Polycarbonate,
Polyethylene,
Acrylonitrile styrene acrylate,
Polybutylene,
Terephthalate,
Polypropylene,
poly(p-phenylene ether),
Acrylnitril-Butadien-Styrol,
Epoxy, and
Liquid-crystal polymer,
wherein at least one sheet of the multilayer sheet stack is a foam sheet or a porous ceramic sheet,
wherein the foam sheet comprises at least one of the following materials:
Polymethacrylimide,
Polyethylene terephthalate,
Polyvinyl chloride,
Polystyrene,
Polyurethane,
Polyphenylsulfone,
Polyethersulfone,
Epoxy foam,
Styrene-acrylonitrile, and
Polyphenyl ether.

28.-29. (canceled)

30. An antenna device, comprising:
a supporting structure,
a radiation or receiving element for radiating or receiving electromagnetic radiation, and
a radome-enclosure including at least one multilayer sheet stack having a plurality of sheets stacked above each other along a stacking direction,
wherein at least one extending sheet of the multilayer sheet stack extends outside the multilayer sheet stack,
wherein the radome-enclosure is mounted to the supporting structure for housing the radiation element.

31. A method of manufacturing a radome-enclosure, the method, comprising:
providing a plurality of sheets;
forming at least one multilayer sheet stack by stacking the plurality of sheets above each other along a stacking direction,
arranging at least one extending sheet of the multilayer sheet stack such that the at least one extending sheet extends outside the multilayer sheet stack.

32. The method according to claim 31, further comprising:
forming the extending sheet by injection molding,
wherein forming the extending sheet by injection molding comprises:
arranging a foil element in a mold,
injecting a mold material in the mold for forming an extending section of the extending sheet and an opening in the extending sheet being covered by the foil element, and
attaching sheets of the multilayer sheet stack in the opening to the foil element.

33. (canceled)
